(19) United States
(12) Patent Application Publication
(10) Pub. No.: US 2002/0085561 A1
(43) Pub. Date: Jul. 4, 2002

(54) Method and system for supporting global IP telephony system

(75) Inventors: Jeong-Hyun Choi, Kyungki-Do (KR); Hyoung-Soo Lee, Seoul (KR); Gi-Moo Choi, Kyungki-Do (KR); Hwan-Jong Kang, Kyungki-Do (KR)

Correspondence Address: FLESHNER & KIM, LLP, P.O. Box 221200, Chantilly, VA, 20153-1200, US

(73) Assignee: LG Electronics Inc.

(21) Appl. No.: 09/970,712

(22) Filed: Oct. 5, 2001

(30) Foreign Application Priority Data
Dec. 30, 2000 (KR) 87330/2000

(51) Int. Cl. H04L 12/56

(52) U.S. Cl. 370/392; 370/475

(57) ABSTRACT

A method for supporting a global IP telephony system in an NAT-based private network is disclosed. The disclosed method includes: establishing a special channel for exchanging information for address translation with a NAT router and identifying the type of a dynamic NAT mode of the NAT router using the special channel. A private address contained in a signaling message forwarded to a public IP terminal is transmitted to the NAT router using the special channel, according to the type of the dynamic NAT mode. A public address is dynamically assigned for the private address by the NAT router and used to replace the private address in a regenerated signaling message. The regenerated signaling message is then transmitted to the public IP terminal. The public address assigned by the NAT router is released when a call is terminated. Since the information required in each H.323 signaling stage is transmitted and received between the gatekeeper and the NAT router using the special channel, the NAT address translation is made transparently.

### BACKGROUND OF THE INVENTION

1. Field of the Invention

The present invention relates to a telephony system and more particularly, an Internet Protocol (IP) telephony system.

2. Background of the Related Art

In general, NAT refers to a function of translating an IP address when an IP packet is forwarded through a router. In a private network, a private address identified only in the private network is used. For an IP packet forwarded to a public network (a network positioned outside the private network), the NAT translates a private address of the IP packet into a public address, which is unique on the Internet.

In a router, the translation of an address field of the IP packet is transparently performed between terminals. To ensure a proper operation of the IP protocol and an upper protocol, as well as replacement of the address field, additional processes are performed by the router, such as a change of a checksum of an Internet Protocol/Internet Control Message Protocol/Transmission Control Protocol (IP/ICMP/TCP) or change of a TCP sequence/acknowledge number.

The NAT is divided into a static NAT and a dynamic NAT, depending on a translation method of the public address and the private address. The dynamic NAT is classified into an NAT single mode (or a port address translation (PAT), masquerading) and an NAT global mode (or a normal dynamic NAT).

The static NAT, as shown in FIG. 1, is used where a public IP address and a private IP address are statically assigned by a one-to-one correspondence and stored in a static NAT table. A packet transmitted by an external IP terminal (an IP terminal positioned externally to the private network) and received by the private network has its public destination address translated into a corresponding private address by the router, according to the static NAT table.

The dynamic NAT is advantageously applied to situations where the number of public addresses is less than the number of private addresses. Using the NAT global mode, as shown in FIG. 2, a packet generated from an internal IP terminal (an IP terminal located in a private network) and forwarded to the public network, has its private transmission address replaced by a public address, which is dynamically assigned from the available public addresses. The dynamically assigned public address is a value meaningful only while a corresponding session is maintained. That is, after the session is terminated, it is not possible to access the internal IP terminal using the dynamically assigned public address.

For an external IP terminal to first access an internal IP terminal, using the dynamic NAT, a static NAT entry (a mapping entry of the public address and the private address) for the corresponding internal IP terminal must be previously generated. Thus, in order to operate a server in the private network, a public IP address for the server needs to be set in advance as a static NAT entry along with the private IP address used for the private network.

The NAT single mode, as shown in FIG. 3, uses only a single public address. Every private address of the private network is translated into the single public address, which has several ports, and the ports correspond to each private address by port number. The port number corresponding to each private address is dynamically assigned as a proxy to uniquely locate the private address.

For the external IP terminal to access the internal IP terminal, even in the NAT single mode, a static NAT entry (comprising a TCP/User Datagram Protocol (TCP/UDP) port number: private address) for a corresponding internal IP terminal should be generated in advance.

The H.323 communication protocol proposed by an ITU-T (International Telecommunication Union-telecommunication Standardization sector) is in the spotlight as a prospective system for multimedia communication in a Packet Based Network (PBN). An IP telephony terminal, conforming to the H.323 protocol, must interact with a gatekeeper, using a Registration, Admission and Status (RAS) message, if the gatekeeper is present.

In order for an IP terminal conforming to the H.323 protocol to generate a call, as shown in FIG. 4, RAS signaling, Q.931 signaling, H.245 signaling, and logical channel signaling should be performed in turn. In the RAS signaling stage, a position of the IP terminal is registered in the gatekeeper and a call origination request is admitted (1, 2, 5, 6). In the Q.931 signaling stage, the allowed originated call is established (3, 4, 7 and 8). In the H.245 signaling stage, a control channel is established for a multimedia service to the established call (9 and 10). In the logical channel signaling stage, channels for transmitting and receiving voice data are established. Thereafter, the voice data are transmitted and received through a media data channel (11).

While each stage is being performed, it informs the next stage of an address and port to be used in the next stage. This method is advantageous in that a required address can be dynamically set in transition from the current stage to the next stage. However, in the private network operated by the NAT, when communication with an external IP terminal is desired, the NAT router does not know the address and port to be used in the next stage.

In the private network operated by the NAT in which both the caller IP terminal (caller) and a callee IP terminal (callee) are located, when the IP terminal and the gatekeeper are operated, the IP telephony service can be supported.

FIG. 5 is a flow chart of messages transmitted and received among the caller, the gatekeeper and the callee to generate a call, when the caller and the callee are located in the NAT private network. For the H.323 protocol, the well known IP addresses and ports are a Gatekeeper discovery multicast IP address (224.0.1.41), a Gatekeeper UDP discovery port (1718), a Gatekeeper UDP RAS port (1719), and an endpoint TCP call signaling port (1720). If the H.323 IP terminal already knows a position of the Gatekeeper, a Gatekeeper discovery process does not need to be performed. When a call is generated between two IP terminals registered in the gatekeeper, the well known requisite port is the gatekeeper RAS port (1719).

When the caller knows the position of the gatekeeper, it transmits an admission request (ARQ) to the gatekeeper to communicate with the other party (S11). And then, when the caller receives an Admission Confirmation (ACF) from the gatekeeper (S12), it starts a Q.931 call signaling by using the Q.931 signaling address and port carried on the ACF (S13). The gatekeeper transmits a call establishing message to the callee located in the NAT private network (S14) and transmits a call proceeding message to the caller (S15). At the End of the Q.931 call signaling, the callee transmits a Q.931 connect message (S21, S22). Since the Q.931 connect message contains an H.245 control channel address and port information, it allows the caller to use the corresponding H.245 control channel address and port when the caller initiates an H.245 logical channel connection procedure afterwards.

After the H.245 control channel is connected, each IP terminal transmits its address and port to the other IP terminal, so as to receive voice data on the H.245 logical channel. And then the caller and the callee transmit Real time Transport Protocol (RTP) voice data to the other party using the corresponding address and port.

Knowing the position of the gatekeeper, the caller should also know a RAS port of the gatekeeper to perform RAS signaling. Since the RAS message transmitted to identify the RAS port is a message used only between the gatekeeper and the H.323 terminal, there is no problem if the address of the gatekeeper is set as the NAT static entry address. When the public IP address of the gatekeeper is exposed, the RAS signaling is normally done. When the Q.931 call signaling is conveyed through the gatekeeper, the Q.931 call signaling is normally made.

Communicating the Q.931 call signaling message directly between the IP terminals, without passing through the gatekeeper presents no problem, if the caller is located in the NAT private network. But if the caller is located in the public network, it is impossible to transmit the Q.931 call signaling message to the callee within the NAT private network. Since the Q.931 address and port of the callee transmitted through the RAS signaling pass the NAT router without address translation, the caller of the public network knows only the private IP address of the callee of the private network. The Q.931 call signaling message is not transmitted to the callee in the NAT private network.

A control channel address and port (the H.245 address and port) required in the H.245 signaling, generated after the Q.931 call signaling, is transmitted by being carried on the Q.931 connect message. Though the Q.931 call signaling has been normally performed through the gatekeeper, the caller is not able to perform the H.245 signaling. Since the address and port for the H.245 signaling are transmitted to the caller without the address translation in the NAT router, the caller of the public network becomes aware of the private address of the callee of the private network.

If the caller is located in the NAT private network and the callee is located in the public network, the H.245 signaling can be performed without any trouble. But, if the caller is located in the public network and the callee is located in the private network, since the H.245 channel connection is attempted in the public network, the caller of the public network becomes aware of the private address of the caller as an address to be used for the H.245 signaling, resulting in a connection failure to the NAT private network.

In case of the RTP channel, after the H.245 control channel is connected, each caller and callee transmits an IP address and port information for establishing an RTP channel. Each terminal can receive media data through this channel from the other party, during the H.245 logical channel signaling, so that two unidirectional connections can be set up.

Though the IP terminal in the NAT private network transmits the IP address and port information for the RTP channel establishment, since the address and port information does not undergo the address translation of the NAT router, the external IP terminal is not able to know the public IP address and port for communicating with the IP terminal in the private network. A problem arises in that the data transmitted by the external IP terminal is not transmitted to the IP terminal of the NAT private network.

For this reason, even though the Saerom technology DialPad or the Microsoft MS-NetMeeting is used in the private network and operated in the NAT mode, a telephone communication attempted from the public network to the private network will fail (due to the incomplete Q.931 signaling). And, when a telephone communication is attempted from the private network to an external network, only the sound going out of the private network is transmitted. Thus, a user can not hear the voice coming from the external network to the private network (due to the RTP channel).

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Therefore, an object of the present invention is to provide a method for supporting a global IP telephony system in an NAT-based private network.

Another object is to provide a transparent network address translation (NAT) of an H.323 protocol message exchanged among a caller, a gatekeeper and a callee so that an IP telephony service can be available between an external network and a private network operated by the NAT.

To achieve at least the above objects in whole or in part, there is provided a method for supporting a global IP telephony system in an NAT-based private network, including establishing a special channel for exchanging information for address translation with a NAT router; identifying the type of a dynamic NAT mode of the NAT router using the special channel; transmitting a private address contained in a corresponding signaling message forwarded to a public IP terminal, to the NAT router using the special channel according to the type of the dynamic NAT mode; receiving a public address dynamically assigned for the private address by the NAT router; replacing the private address with the public address to regenerate the signaling message and transmitting it to the public IP terminal; and releasing the public address assigned from the NAT router when a call is terminated.

To achieve at least these advantages in whole or in parts, there is further provided a method for supporting a global IP telephony system in an NAT-based private network, including establishing a special channel identifying the type of a dynamic NAT mode of the NAT router using the special channel; transmitting private IP address and port information contained in each signaling message forwarded to a public IP terminal, to the NAT router using the special channel when a message is transmitted between a private IP terminal and the public IP terminal if the dynamic NAT mode is an NAT single mode; dynamically assigning a public IP address and port for the private IP address and port by the NAT router; replacing the private IP address and port with the assigned public IP address and port, regenerating the signaling message and transmitting it to the public IP terminal; and releasing every public IP address and port assigned from the NAT router when a call is terminated.

To achieve at least these advantages in whole or in part, there is further provided a method for supporting a global IP telephony system in an NAT-based private network, including establishing a special channel identifying the type of a dynamic NAT mode of the NAT router using the special channel; transmitting private IP address information contained in each signaling message forwarded to a public IP terminal, to the NAT router using the special channel when a message is transmitted between a private IP terminal and the public IP terminal if the dynamic NAT mode is an NAT global mode; dynamically assigning a public IP address for the private IP address by the NAT router; replacing the private IP address with the assigned public IP address, regenerating the signaling message and transmitting it to the public IP terminal; and releasing the public IP address assigned from the NAT router when a call is terminated.

The objects of the invention may be achieved in whole or in part by a global internet protocol (IP) telephony method, including receiving an admission request (ARQ) message transmitted by a source terminal and intended for receipt by a destination terminal; generating an admission confirm (ACF) message having public call signaling information corresponding to private call signaling information contained in the ARQ message; and communicating the ACF message to the source terminal.

The objects of the invention may be further achieved in whole or in part by a global internet protocol (IP) telephony method, including retrieving a private destination address from a first channel signaling message received from a source terminal; regenerating the first channel signaling message as a second channel signaling message; replacing private destination address within the second channel signaling message with a public destination address; and communicating the second channel signaling message to a destination terminal.

The objects of the invention may be further achieved in whole or in part by a global internet protocol (IP) telephony system, including a gatekeeper that performs a call processing function for a terminal assigned to a private network; a router that interconnects a private terminal, within a private network, with a public terminal within a public network; a private channel between the router and the gatekeeper that communicates public and private address information, wherein the gatekeeper and router communicate through the private channel to generate and manage proxy IP addresses of the router and gatekeeper to support H.323 protocol telephony communication between the private and public terminals.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the construction of a related art NAT static mode router;

FIG. 2 illustrates a construction of a general dynamic global mode NAT router;

FIG. 3 illustrates a construction of a general dynamic single mode NAT router;

FIG. 4 illustrates a flow chart of a related art signaling message for generating an H.323 call between a caller, a gatekeeper and a callee;

FIG. 5 illustrates a construction of an H.323 signaling channel connected between the caller, the gatekeeper and the callee;

FIG. 6 illustrates a construction of the connection among a NAT router, a gatekeeper, and an IP terminal in a NAT private network;

FIG. 7 illustrates a flow chart of an interworking method between the gatekeeper and the NAT router;

FIGS. 8A, 8B and 8C illustrate flow charts of an interworking method between the gatekeeper and the NAT router using a NAT single mode; and

FIGS. 9A and 9B illustrate flow charts of an interworking method between the gatekeeper and the NAT router using a NAT global mode.

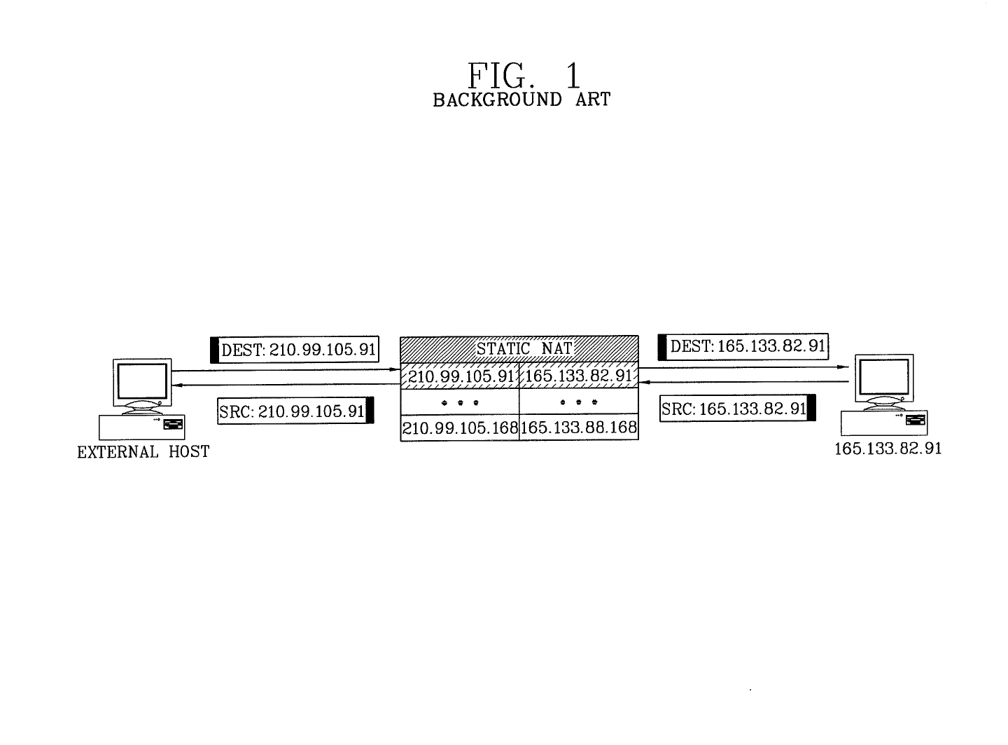

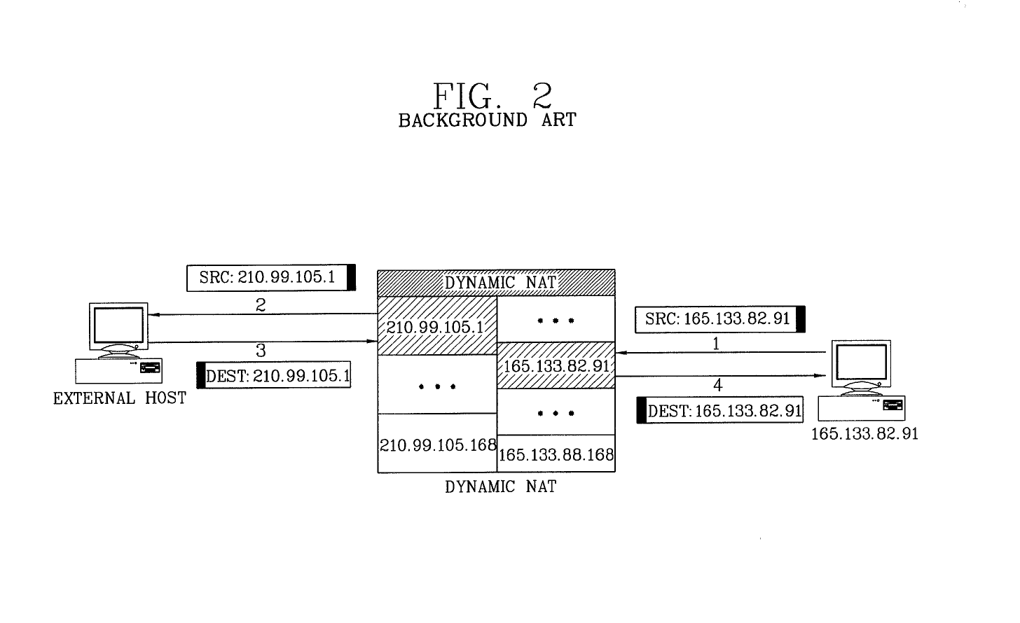

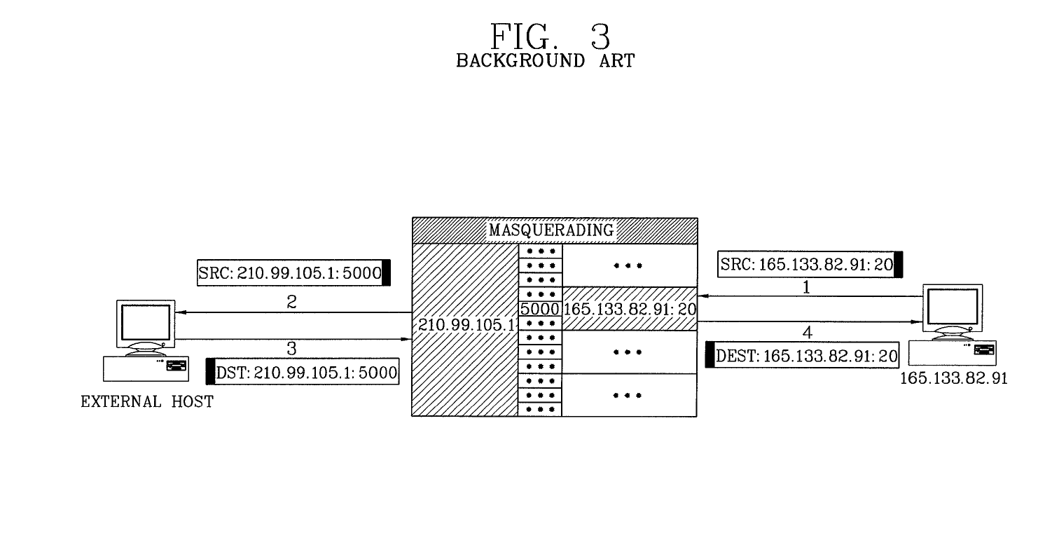

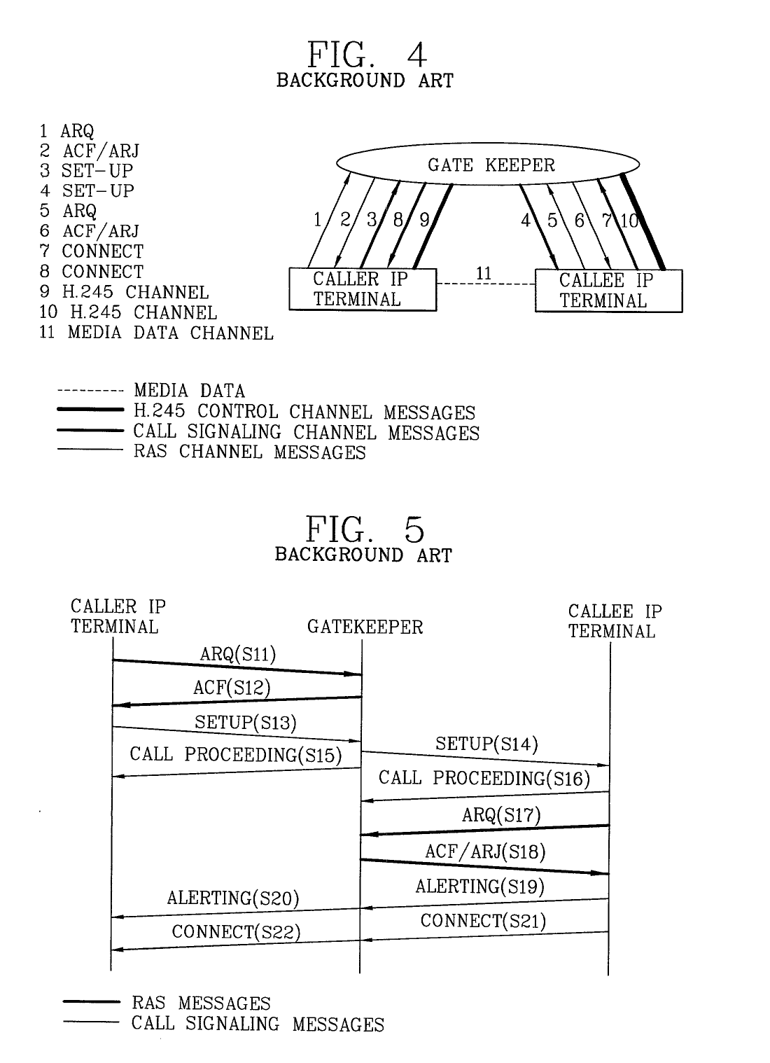

### DETAILED DESCRIPTION OF PREFERRED EMBODIMENTS

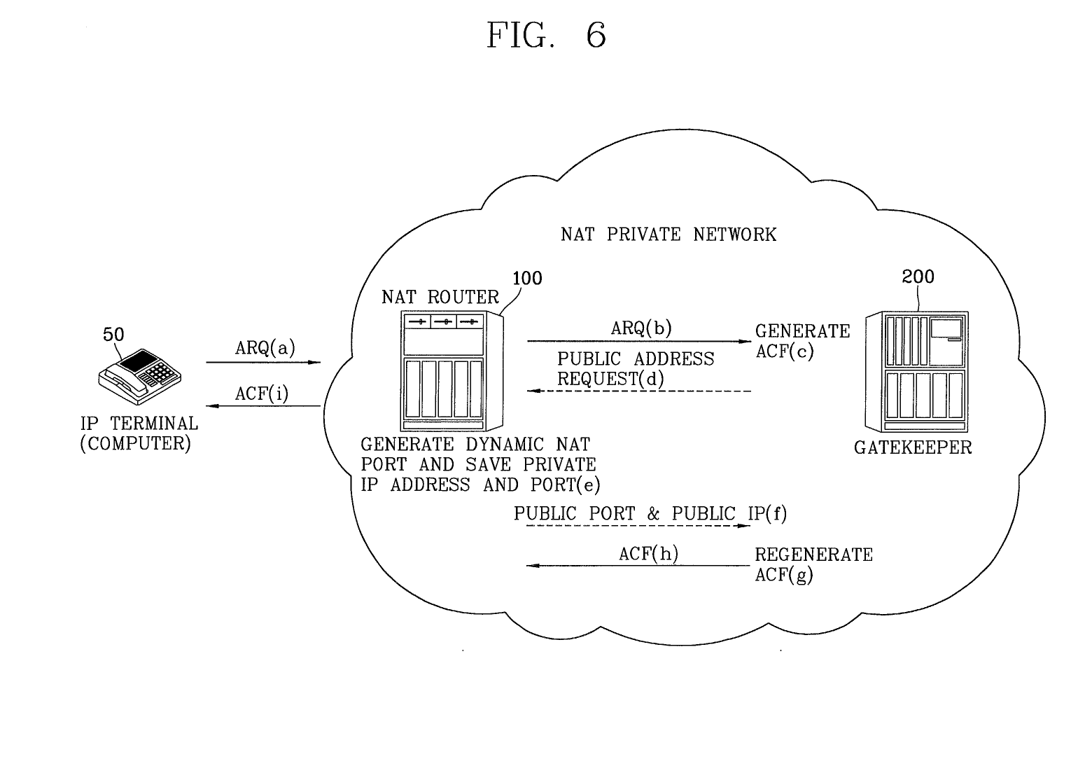

FIG. 6 illustrates a construction of a connection among a NAT router, a gatekeeper and an IP terminal in a NAT private network, in accordance with a preferred embodiment of the invention. An IP terminal 50, positioned outside the NAT private network, requests an IP telephony service from the NAT private network. NAT router 100, positioned in the NAT private network, performs routing using a dynamic NAT function. Gatekeeper 200, positioned in the NAT private network, performs a call process function including a call admission and authorization.

To establish an H.323 protocol call between IP terminals, the NAT router 100 needs to know a RAS address and port, a Q.931 address and port, an H.245 control channel address and port, and an RTP channel address and port. Accordingly, a particular channel is established between the gatekeeper 200 and the NAT router 100, through which all address and port information are transmitted and received.

The gatekeeper 200 checks whether the router uses the NAT in booting and attempts re-connection if the particular channel is cut off.

The information transmitted and received between the NAT router 100 and the gatekeeper is different depending on the dynamic NAT mode used. For NAT single mode, the NAT router 100 should store information on the port used in each H.323 message as well as private address information of the gatekeeper 200 and the H.323 terminal (that is, the H.323 terminal in the private network). Therefore, the gatekeeper 200 should participate in all signaling procedures (that is, a RAS signaling stage, a Q.931 signaling, an H.245 control signaling, an H.245 open logical channel signaling) between caller and callee H.323 terminals, to inform the NAT router 100 of the port information used in each procedure.

For NAT global mode, the NAT router 100 needs only know the address information of the gatekeeper 200 and the private H.323 terminal (not shown). Accordingly, when the RAS message is exchanged via the gatekeeper 200, the gatekeeper 200 may inform the private address of the H.323 terminal. As the NAT router obtains the private address of the H.323 terminal, in a follow-up signaling stage, the gatekeeper 200 replaces the private addresses of the gatekeeper 200 and the private H.323 terminal of a message, to be transmitted to the public H.323 terminal 50, with a public address and transmits the message.

A method for supporting a global IP telephony system in an NAT-based private network using the NAT single mode or the NAT global mode will now be described, with reference to FIGS. 6, 7 and 8A through 8C.

A) NAT Single Mode:

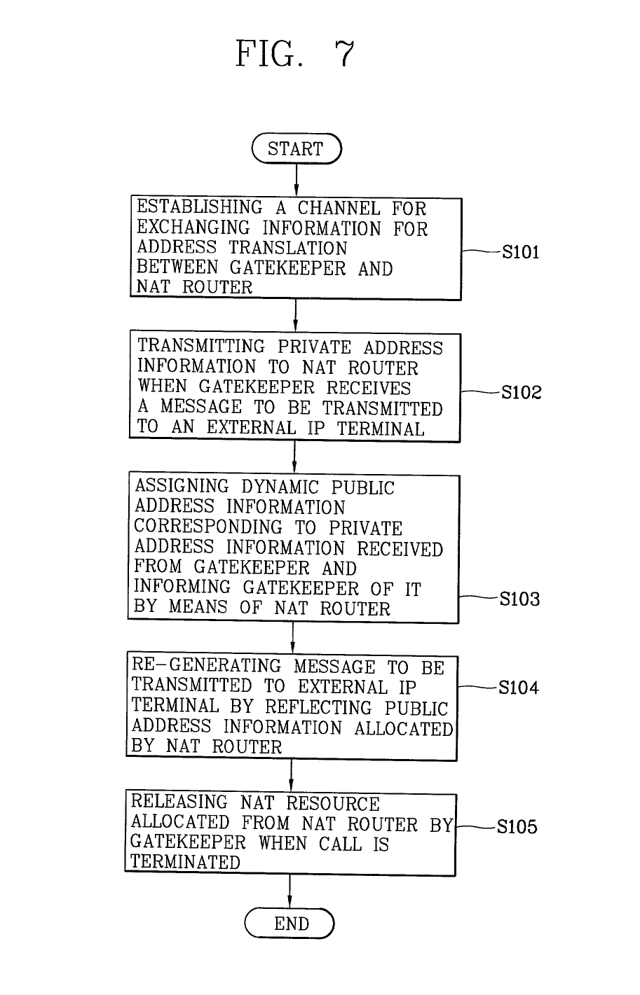

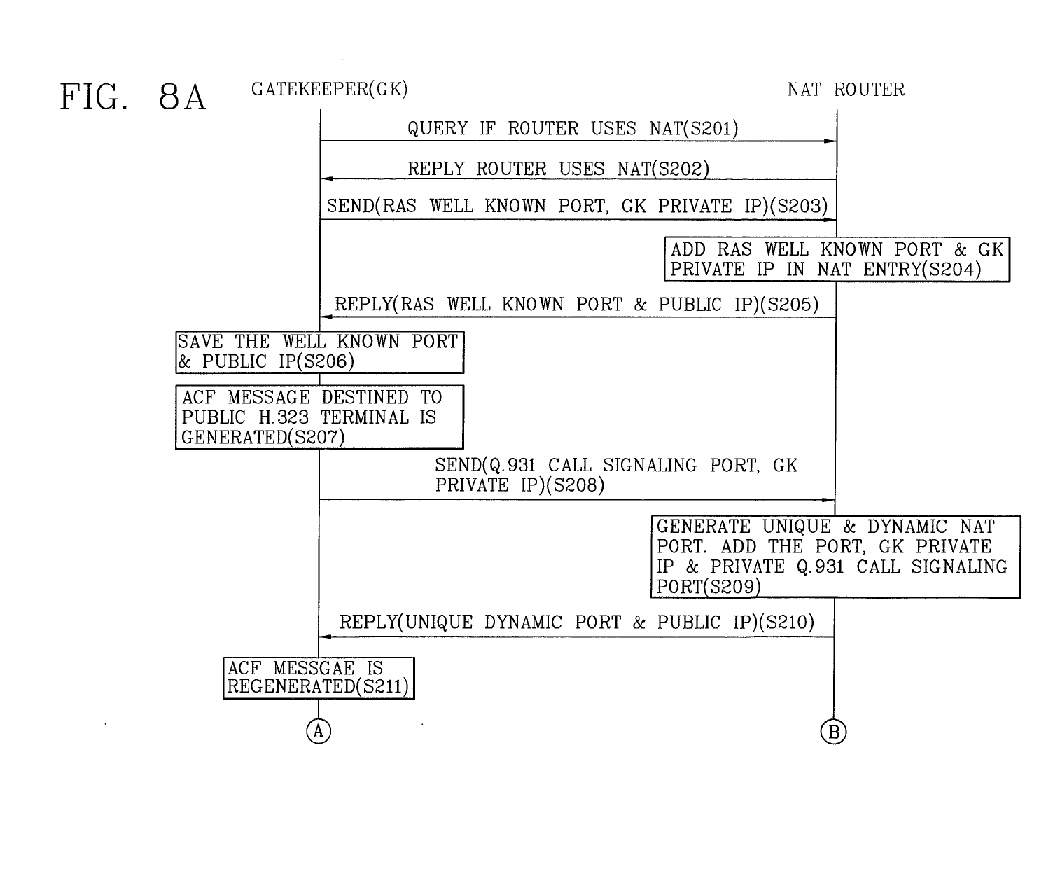

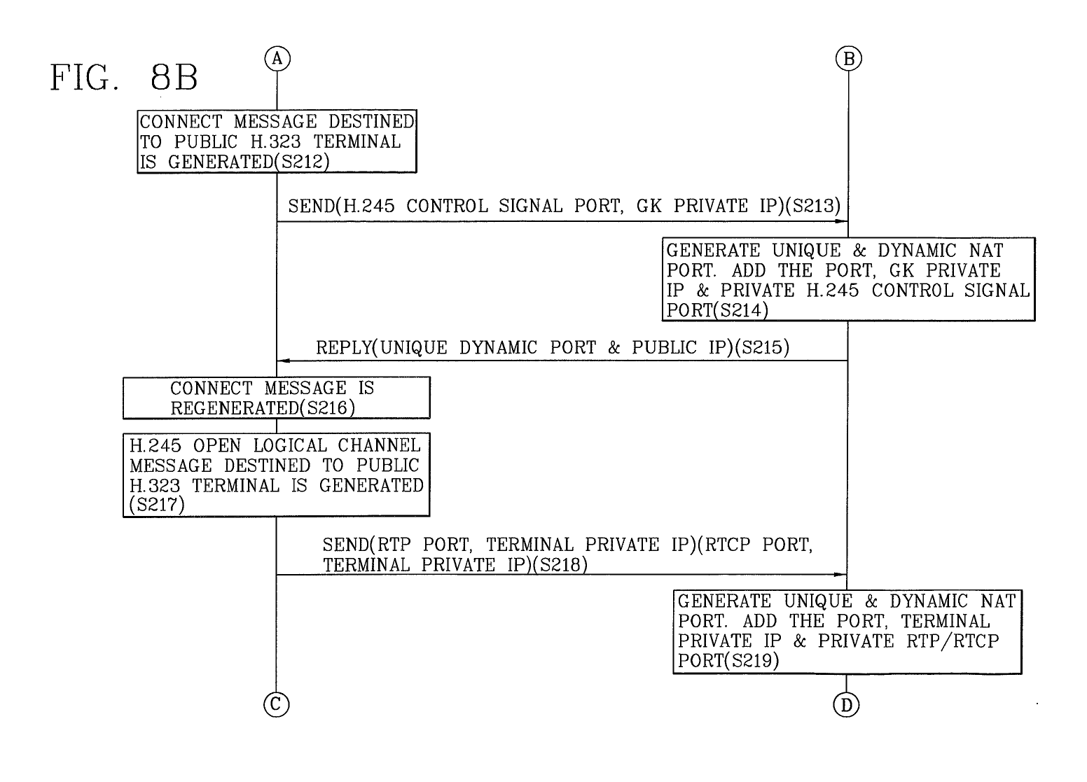

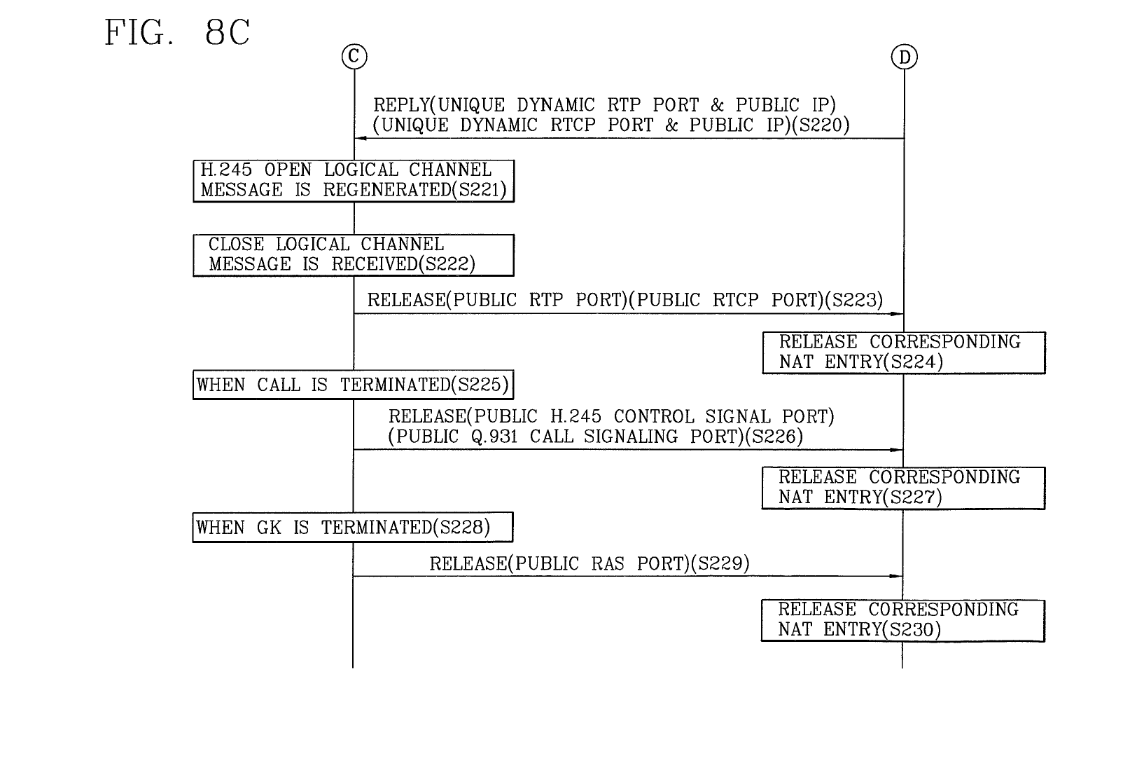

FIG. 7 is a flow chart of an interworking method between the gatekeeper and the NAT router and FIGS. 8A, 8B and 8C are flow charts of an interworking method between the gatekeeper and the NAT router using a NAT single mode.

Since the port information contained in a message transmitted at each signaling stage of the H.323 varies, the gatekeeper 200 participates in all the procedures of the H.323 signaling to inform the NAT router 100 of the required port information and the public IP address information. The gatekeeper 200 accomplishes this by establishing a channel for information exchange with the NAT router 100, after finishing the booting operation. Accordingly, a channel is established between the NAT router 100 and the gatekeeper 200 for information exchange (S101).

The gatekeeper 200 checks whether the router 100 is using the NAT through the established information exchanging channel (S201). If the router 100 is using NAT, the router 100 transmits a response indicating its use of the NAT to the gatekeeper (S202). The gatekeeper 200 transmits its own private IP address (that is, a GK private IP address) and RAS well known port information to the NAT router 100 (S203). The NAT router 100 adds the received GK private IP address and the RAS well known port information to the NAT entry (S204). The NAT router 100 assigns a public IP address for the received GK private IP address, and transmits the assigned public IP address and the RAS well known port information to the gatekeeper 200 (S205). Then, the gatekeeper 200 stores the public IP address and the RAS well known port information as received (S206).

Thereafter, when a public IP terminal (that is, a caller) 50 located in an external network transmits an Admission ReQuest (ARQ) message (a), requesting an IP telephony call, to the NAT router 100, the NAT router 100 transmits a subsequent ARQ (Admission ReQuest) message (b) to the gatekeeper 200. Such a message (a) is sent for the caller (50) to communicate with the private IP terminal (that is a callee) located in the NAT private network. Upon receipt of the ARQ message (b), the gatekeeper 200 generates an Admission ConFirm (ACF) message for the public IP terminal (S207) (c). The gatekeeper 200 transmits the private IP address and port information, recorded in the ACF message generated in step S207, through the channel established for information exchange between itself and the NAT router 100, to request the public IP address and dynamic port information (S208) (d) (S102). In response, the NAT router 100 generates a unique and dynamic NAT port and stores the generated dynamic NAT port along with the received private IP address and port information (that is, private Q.931 call signaling port information) (S209) (e). Thereafter, the NAT router 100 transmits the dynamic NAT port information and the public IP address to the gatekeeper 200 (S210) (f) (S103). The gatekeeper 200 regenerates the ACF message using the dynamic NAT port information and the public IP address (g) and transmits it to the NAT router 100 (S211) (h) (S104). Then, the NAT router 100 transmits the ACF message to the caller IP terminal 50 (i).

When the gatekeeper 200 receives a connect message from the callee, it transmits the private IP address and port information to be used for the H.245 control signaling to the NAT router 100, through the channel established for information exchange between itself and the NAT router 100 (S212, S213). The NAT router 100 assigns a unique and dynamic NAT port as the port for the H.245 control signaling so that the H.245 control signaling can be normally performed with the public IP terminal 50. The NAT router 100 stores the assigned dynamic NAT port together with the IP address and port transmitted from the gatekeeper 200 in step S213 (S214). And then, the NAT router 100 transmits the unique and dynamic NAT port and the public IP address information to the gatekeeper 200 (S215). The gatekeeper 200 regenerates the connect message using the unique and dynamic NAT port and the public IP address information, as received, and transmits it to the caller through the Q.931 control signaling channel (S216).

After the Q.931 control signaling is performed, when an H.245 open logical channel message is generated, the gatekeeper 200 transmits a private RTP port for establishing an RTP channel, the private IP address of the callee and private Real time Transport Control Protocol (RTCP) port information to the NAT router 100 (S217, S218). The NAT router 100 generates a unique and dynamic NAT port for the H.245 open logical channel signaling and stores the generated dynamic NAT port information, the received private IP address of the callee, and the private RTP/RTCP port information (S219). Then, the NAT router 100 transmits the dynamic RTP port, the dynamic RTCP port and the public IP address information to the gatekeeper 200 (S220). The gatekeeper 200 replaces the address and port information to be used for the RTP and the RTCP with the dynamic port and the public IP address received from the NAT router 100, regenerates the H.245 open logical channel message, and then performs the H.245 open logical channel signaling (S221).

Thereafter, when a gatekeeper 200 receives a close logical channel message, used for closing a media channel that transmits and receives RTP data employing H.245 logical channel signaling, it checks a closed public RTP port and the public RTCP port information and requests the release of the ports (S222, S223) from the NAT router 100. Then, the NAT router 100 releases the corresponding NAT entry (S224).

When a call is terminated, if the gatekeeper 200 receives a Disengage ReQuest (DRQ) message from the H.323 terminal or transmits the DRQ message, it releases every IP address and port information assigned by the NAT router 100 to the corresponding call (S226, S227). Also, when the gatekeeper 200 receives or transmits a call termination message (release complete), it releases every public IP address and port assigned by the NAT router 100 to the corresponding call (S229, S230) (S105).

B) NAT global mode:

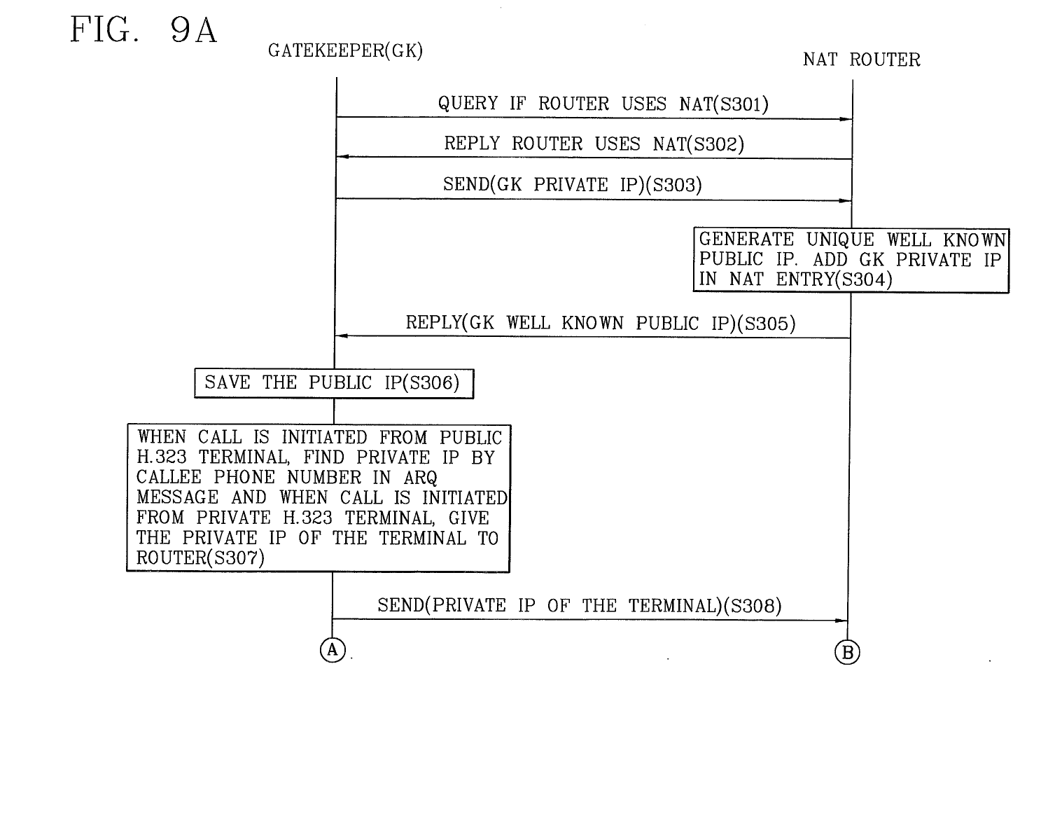

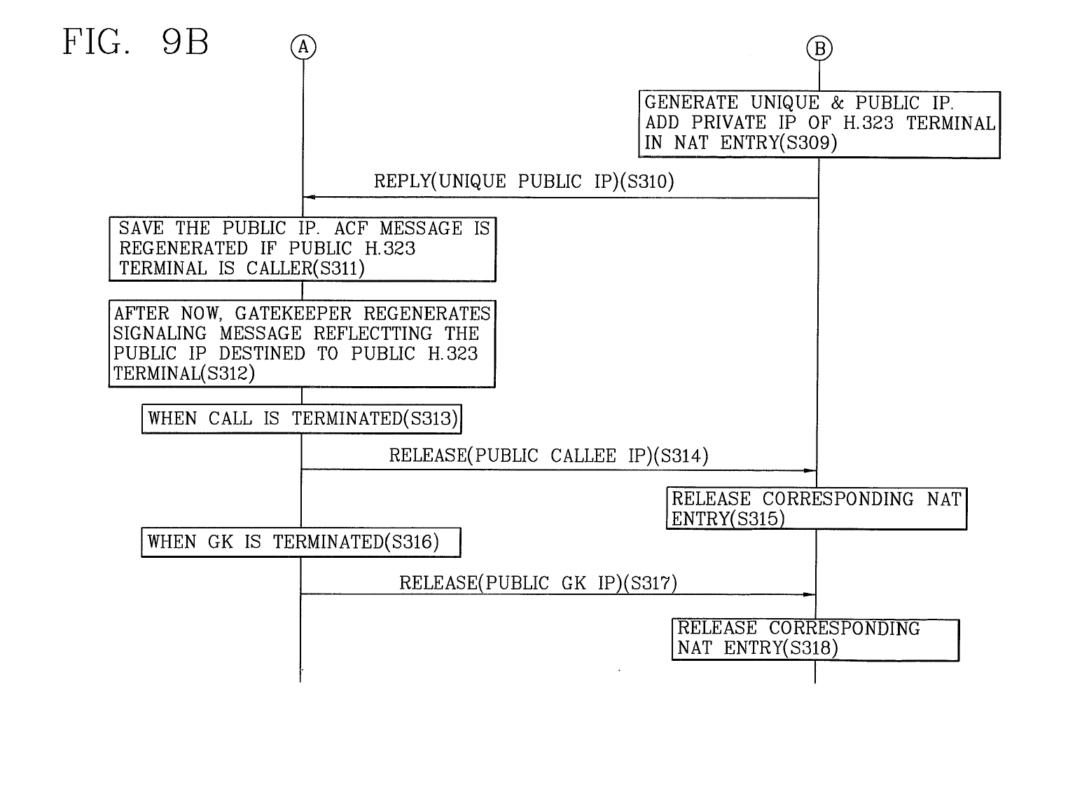

FIGS. 9A and 9B are flow charts of an interworking method between the gatekeeper and the NAT router in a NAT global mode. For a message used in each H.323 signaling procedure to include the public IP address information of the H.323 terminal, the gatekeeper 200 establishes a channel for exchanging the IP address of the H.323 terminal with the NAT router 100 (S101). The gatekeeper 200 checks, through the information exchange channel, whether the router 100 is using the NAT (S301). If the router 100 is using the NAT, the router 100 informs the gatekeeper 200 of the use (S302).

The gatekeeper 200 transmits its own private IP address (that is, the GK private IP address) to the NAT router 100, through the established information exchange channel (S303). Then, the NAT router 100 selects a unique and dynamic public IP address from the NAT public address pool, assigns the selected dynamic public IP address to correspond to the GK private IP address, and adds the assigned dynamic public IP address and the received GK private IP address to the NAT entry (S304). Router 100 transmits the assigned GK public IP address to the gatekeeper 200 (S305) and the gatekeeper 200 stores the received public IP address (S306).

When a call is attempted from the NAT private network to an outside terminal, the gatekeeper 200 receives an H.245 logical channel signaling message. The gatekeeper 200 searches the message for a private IP address of the private H.323 terminal, which is attempting the call, and transmits it to the NAT router 100 (S307, S308).

On the other hand, if a public H.323 terminal located in an external network attempts a call to the NAT private network, the gatekeeper 200 searches the received ARQ message for a private IP address corresponding to a phone number of a callee H.323 terminal and transmits it to the NAT router 100 (S307, S308) (S102). NAT router 100 assigns the unique and dynamic public IP address for the private IP address of the callee in the NAT global mode and adds the assigned public IP address and the received private IP address of the H.323 terminal to the NAT entry (S309). Then, the NAT router 100 transmits the assigned dynamic public IP address to the gatekeeper 200 (S310) (S103). Gatekeeper 200 stores the received public IP address and, if the call is attempted by the public H.323 terminal, regenerates the ACF message (S311) (S104).

If the gatekeeper 200 is not provided with the assigned public IP address by the NAT router 100, for some reason, it generates an Admission Rejection (ARJ) message and transmits it to the caller to terminate the call.

Gatekeeper 200 regenerates the signaling message set for the public H.323 terminal and replaces the private IP address with the assigned dynamic public IP address. Then, the gatekeeper 200 transmits the regenerated message (S312) (S104).

When a call is terminated, the gatekeeper 200 releases the public IP address assigned by the NAT router 100 (S316˜S318) (S105).

As so far described, the method for supporting a global IP telephony system in an NAT-based private network according to the present invention has many advantages.

Since the information exchanging channel is established between the gatekeeper and the NAT router, the NAT mode of the NAT router is identified using the established information exchanging channel. Information required in each H.323 signaling stage is transmitted and received between the gatekeeper and the NAT router using the established information exchanging channel, according to the NAT mode, so the NAT address translation is made transparently.

In addition, since the H.323 signaling is normally performed between the H.323 terminals, respectively located in the NAT private network and the public network, the IP telephony service can be provided irrespective of which network contains the terminal initiating the call.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for supporting a global IP telephony system, comprising:
establishing a special channel for exchanging address translation information with a Network Address Translation (NAT) router;
identifying a dynamic NAT mode of the NAT router using the special channel;
transmitting a private address, contained in a corresponding signaling message forwarded to a public IP terminal, to the NAT router using the special channel according to the dynamic NAT mode;
receiving a public address dynamically assigned for the private address by the NAT router;
replacing the private address with the public address to regenerate the signaling message and transmitting the signaling message to the public IP terminal; and
releasing the public address assigned from the NAT router when a call is terminated.

2. The method of claim 1, wherein in a case that the call is attempted from a NAT private network to a public network, the public address is generated using the private address of a caller extracted from an H.245 logical channel signaling message, while, in the case that the call is attempted from the public network to the NAT private network, the public address is generated using a phone number of a callee extracted from an RAS message.

3. The method of claim 1, wherein in a case that the NAT router is operated in a NAT single mode, the private address represents a private IP address and a port to be used for the signaling message, while, in the case that the NAT router is operated in a NAT global mode, the private address represents the private IP address to be used for the signaling message.

4. The method of claim 1, wherein in a case that the dynamic NAT mode is a NAT single mode, the public address represents a single and common public IP address and a port, while, in the case that the dynamic NAT mode is a NAT global mode, the public address represents the public IP address to be used for the signaling message.

5. A method for supporting a global IP telephony system in a Network Address Translation (NAT) based private network, comprising:
establishing a special channel and identifying a dynamic NAT mode of a NAT router, using the special channel;
transmitting a private IP address and a private port identifier, contained in a signaling message forwarded to a public IP terminal, to the NAT router using the special channel in a case that the dynamic NAT mode is a NAT single mode and a call is attempted from the public IP terminal to a private IP terminal;
dynamically assigning a public IP address and a public port identifier for the private IP address and the private port identifier by the NAT router;
replacing the private IP address and the private port identifier with the assigned public IP address and the public port identifier, to regenerate the signaling message and to transmit the signaling message to the public IP terminal; and
releasing the public IP address and the public port identifier assigned to the call by the NAT router when the call is terminated.

6. The method of claim 5, wherein the signaling message forwarded to the public IP terminal comprises one of:
an RAS signaling message that registers a position of an IP terminal and a telephony admission;
a Q.931 signaling message that establishes an originating call;
an H.245 call signaling message that supports a multi-media service; and
an H.245 logical channel signaling message that establishes a channel for transmitting and receiving voice data.

7. The method of claim 5, wherein the public port identifier is assigned by the NAT router uniquely and dynamically so that signaling messages forwarded to the public IP terminal can be discriminated from each other.

8. The method of claim 5, further comprises:
transmitting the private IP address, contained in the signaling message forwarded to the public IP terminal, to the NAT router using the special channel, in a case that the dynamic NAT mode is a NAT global mode and the call is attempted from the public IP terminal to the private IP terminal;
dynamically assigning the public IP address for the private IP address by the NAT router;
replacing the private IP address with the assigned public IP address, regenerating the signaling message and transmitting the signaling message to the public IP terminal; and
releasing the public IP address assigned by the NAT router, when the call is terminated.

9. The method of claim 8, wherein the signaling message represents an RAS message.

10. The method of claim 8, further comprising replacing the private IP address contained in the next signaling messages, which are to be transmitted after the signaling message is transmitted, with the public IP address, regenerating and transmitting the next signaling messages.

11. The method of claim 10, wherein the next signaling messages comprise at least one of:
a Q.931 signaling message that establishes an originating call;
an H.245 call signaling message that supports a multimedia service; and
an H.245 logical channel signaling message that establishes a channel to transmit and receive voice data.

12. The method of claim 8, wherein when the call is attempted from the public IP terminal to the private IP terminal, the private IP address contained in the signaling message forwarded to the public IP terminal can be searched using a phone number of a callee IP terminal extracted from an ARQ message.

13. A network telephony method, comprising:
receiving an admission request (ARQ) message transmitted by a source terminal and destined for a destination terminal;
generating an admission confirm (ACF) message having public call signaling information corresponding to private call signaling information contained in the ARQ message; and
communicating the ACF message to the source terminal.

14. The method of claim 13, further comprising:
establishing a private channel between a router and a gatekeeper;
communicating the private call signaling information from the gatekeeper to the router, through the private channel;
translating the private call signaling information to the public call signaling information using a network address translation (NAT) of the router; and
communicating the public call signaling information from the router to the gatekeeper, through the private channel.

15. The method of claim 13, wherein a particular value of the public call signaling information is dynamically determined by a router, based on values available for assignment.

16. The method of claim 13, further comprising:
receiving a first connect message from the destination terminal;
regenerating the first connect message as a second connect message;
replacing private control signaling information within the second connect message with public control signaling information; and
communicating the second connect message to the source terminal through a call signaling channel identified by the public call signaling information.

17. The method of claim 13, further comprising:
establishing a private channel between a router and a gatekeeper;
receiving a first connect message from the destination terminal;
regenerating the first connect message as a second connect message;
communicating the private call signaling information, contained in the first connect message, from the gatekeeper to the router, through the private channel;
translating the private call signaling information to the corresponding public call signaling information using a network address translation (NAT) of the router;
communicating the public call signaling information from the router to the gatekeeper, through the private channel;
replacing private control signaling information within the second connect message with public control signaling information; and
communicating the second connect message to the source terminal through a call signaling channel identified by the public call signaling information.

18. The method of claim 13, further comprising:
establishing a private channel between a router and a gatekeeper;
communicating private channel signaling information from the gatekeeper to the router, through the private channel;
translating the private channel signaling information to public channel signaling information using a network address translation (NAT) of the router;
communicating the public channel signaling information from the router to the gatekeeper, through the private channel.

19. The method of claim 13, further comprising:
assigning the public call signaling information to a call signaling channel established between the source and destination terminals; and
releasing the public call signaling information for use by another call signaling channel, when a call between the source and destination terminals is terminated.

20. A network telephony method, comprising:
retrieving a private destination address from a first channel signaling message received from a source terminal;
regenerating the first channel signaling message as a second channel signaling message;
replacing the private destination address within the second channel signaling message with a public destination address; and
communicating the second channel signaling message to a destination terminal.

21. The method of claim 20, further comprising:
assigning the public destination address to a logical channel established between the source and destination terminals; and
releasing the public destination address for use by another logical channel, when a call between the source and destination terminals is terminated.

22. The method of claim 20, further comprising:
establishing a private channel between a router and a gatekeeper;
communicating the private destination address from the gatekeeper to the router, through the private channel;
translating the private destination address to the public destination address using a network address translation (NAT) of the router; and
communicating the public destination address from the router to the gatekeeper, through the private channel.

23. A network telephony system, comprising:
a gatekeeper that performs a call processing function for a terminal assigned to a private network;
a router that interconnects the private terminal with a public terminal within a public network;
a private channel between the router and the gatekeeper that communicates public and private address information, wherein
the gatekeeper and router communicate through the private channel to generate and manage proxy addresses of the router and gatekeeper to support a prescribed protocol telephony communication between the private and public terminals.
